(19) United States
(12) Patent Application Publication
(10) Pub. No.: US 2007/0134057 A1
(43) Pub. Date: Jun. 14, 2007

(54) PIVOT ASSEMBLY AND METHOD FOR ASSEMBLING THE SAME

(76) Inventors: Ching-Hung Chang, Taoyuan County (TW); Wen-Kuan Peng, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 11/562,995

(22) Filed: Nov. 23, 2006

(30) Foreign Application Priority Data
Nov. 30, 2005 (TW) 094142227

(51) Int. Cl. F16J 1/16

(52) U.S. Cl. 403/150

(57) ABSTRACT

A pivot assembly for connecting a rotating body and a base includes a groove formed on the base, a support section formed on the rotating body, and two pivot bolts. The pivot bolts are inserted into a hole penetrating the support section from two sides of the support section respectively so as to cover a front end of each pivot bolt in the hole and expose a back end of each pivot bolt in a recess formed above the support section. The support section is inserted into the groove so that the hole corresponds to the cavity. Then, a plug is plugged into the recess to hold the back end of pivot bolts so that the pivot bolts can rotate smoothly in the cavities.

### BACKGROUND OF THE INVENTION

1. Field of the Invention

The invention relates to a pivot assembly, and more particularly, to a pivot assembly that uses pivot bolts movably inserted to connect a rotating body and a base.

2. Description of the Prior Art

A pivot assembly according to the prior art is mainly used for connection of two objects, so as to form an included angle or facilitate folding actions. Therefore, the pivot assembly not only connects two objects so as to rotate easily, but also provides force in the connection.

Please refer to FIG. 1. FIG. 1 is a diagram of a pivot assembly 10 according to the prior art. A rotating body 11 has a support section 12 protruding on one side. A hole is formed in the support section 12 and a pivot bolt 13 formed of a solid material, such as a metal, is inserted into and fixed in the hole with a tight fit or adhesion. Two ends of the pivot bolt 13 protrude slightly from two sides of the support section 12 to fit into the hole. A base 14 has a groove 15 opposite to one end of the support section 12 of the rotating body 11. The size of the groove 15 just accommodates the support section 12 of the rotating body 11. Two end-faces of the groove 15 each have a cavity 16 corresponding to the protruding parts of the pivot bolt 13, respectively. When the support section 12 is installed in the groove 15, the two ends of the pivot bolt 13 can be inserted into the cavities 16 of the groove 15. The pivot bolt 13 uses a sliding fit to rotate smoothly in the cavity 16 so that the rotating body 11 and the base 14 are connected to form an included angle or facilitate folding actions.

To insert the pivot bolt 13 into the cavity 16, the pivot bolt 13 has to be tilted and forced in the cavity 16, because the pivot bolt 13 is fixed in the support section 12. The force and angle of insertion, as above-mentioned, make the pivot bolt 13 hard to install and may damage the pivot bolt 13 when forcing the pivot bolt 13 in, such that the pivot bolt 13 cannot rotate smoothly in the cavity 16. Moreover, for convenience in forcing the pivot bolt 13 in, and to prevent damage from the pivot bolt 13, the pivot bolt 13 does not have large protrusions from the support section 12 in the pivot assembly 10 according to the prior art, so the pivot bolt 13 can be easy to insert into the cavity 16. However, this means that the pivot bolt 13 cannot be inserted deeply into the cavity 16 to provide enough support, so the rotating body 11 can easily separate from the base 14 because of the lower connecting strength of the pivot assembly 10. Therefore, the pivot assembly 10 according to the prior art should be improved.

### SUMMARY OF THE INVENTION

One objective of the present invention is therefore to provide a pivot assembly utilizing a separate architecture to insert the pivot bolts into the recess respectively so as to prevent from damage and increase the strength of connection for rotating the pivot bolts smoothly in the recess.

Another objective of the present invention is to provide a method for assembling a pivot assembly by inserting the separate pivot bolts into the cavities through the recess, so that make assembling the pivot bolts easier and keep the profiles clean so as to increase the quality.

Another objective of the present invention is to provide a pivot assembly with the adjuster so as to speed assembling the pivot bolts.

To achieve the above-mentioned objective, the present invention provides a pivot assembly for connecting a rotating body and a base comprising a groove formed on the base with a cavity at each end-face of the groove; a support section formed on the rotating body to accommodate the groove, the support section having a hole penetrating through two end-faces of the support section corresponding to the cavities of the groove, and a recess above the support section interlinked to the hole; and two pivot bolts for movably inserting into the hole at two sides of the recess, a front end of each pivot bolt protruding out of the hole for inserting into the cavity.

The present invention provides a method for assembling a pivot assembly comprising (a) inserting two pivot bolts into a hole penetrating a support section from two sides of the support section respectively so as to cover a front end of each pivot bolt in the hole and expose a back end of each pivot bolt in a recess formed above the support section; (b) putting the support section into a groove formed on a base so that the hole corresponds to a cavity formed on each end-face of the groove; (c) pushing a back end of each pivot bolt away from the groove so that the front end of each pivot bolt inserts into the cavity; and (d) fixing the pivot bolts in the hole.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a pivot assembly according to the prior art.

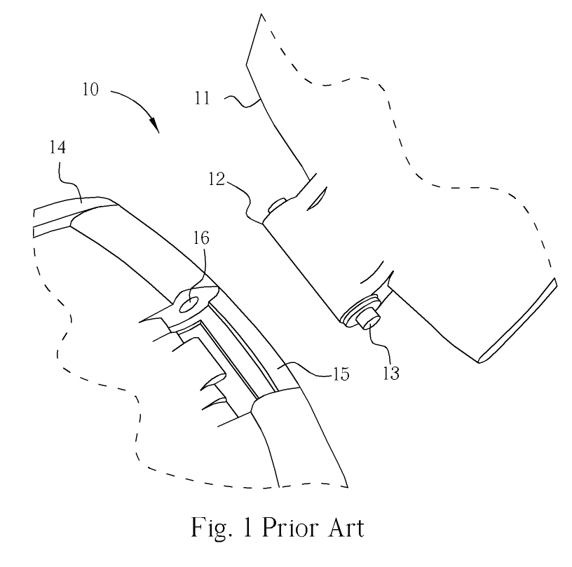

FIG. 2 is a diagram of a first embodiment of a pivot assembly according to the present invention.

FIG. 3 is a diagram of installation of the pivot bolts in FIG. 2.

FIG. 4 is a sectional view of the pivot assembly in FIG. 2.

FIG. 5 illustrates fixing the pivot bolts in FIG. 2 with a plug.

FIG. 6 is a sectional view of a second embodiment of the pivot assembly according to the present invention.

### DETAILED DESCRIPTION

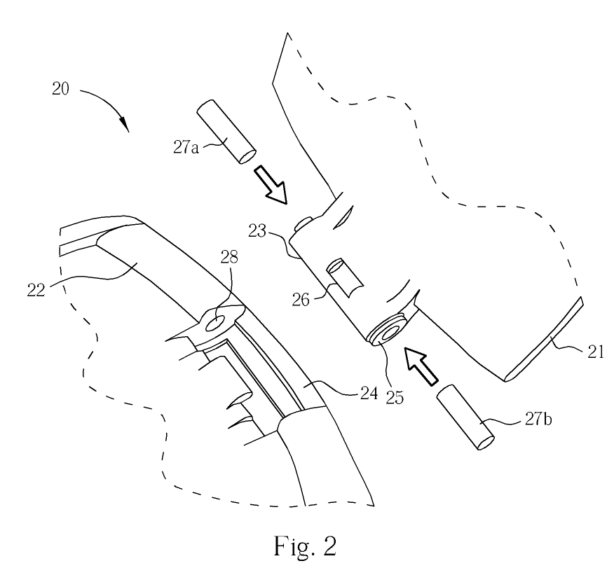

Please refer to FIG. 2. FIG. 2 is a diagram of a first embodiment of a pivot assembly according to the present invention. The pivot assembly 20 of the first embodiment according to the present invention includes a rotating body 21 and a base 22. The rotating body 21 has a support section 23 formed on one end. The base 22 has a groove 24 formed on an end opposite to the support section 23, which can just accommodate the support section 23. The groove 24 and the support section 23 are connected so that the rotating body 21 and the base 22 can form an included angle or facilitate folding actions.

The support section 23 has a hole 25 formed in the horizontal direction. The hole 25 has the same diameter from one side to another side of the support section 23. The support section 23 has a recess 26 formed above the hole 25 in the vertical direction. The recess 26 connects to the center of the hole 25, so the center of the hole 25 is an open channel and the two ends of the hole 25 are a closed channel. Two pivot bolts 27a, 27b are cylindrical with the same diameter made of a solid material, such as metal. The diameter of the pivot bolts 27a, 27b is equal to the diameter of the hole 25. The total length of the pivot bolts 27a, 27b is shorter than the length of the hole 25, and the individual length is longer than one end of the closed channel of the hole 25, so as to insert into the hole 25 respectively.

In addition, the groove 24 is formed on the end of the base 22 opposite to the support section 23 of the rotating body 21. The size of the groove 24 just accommodates the support section 23 of rotating body 21. Two end-faces of the groove 24 each have a cavity 28 respectively opposite to two sides of the hole 25 of the support section 23. The cavity 28 is round with a diameter slightly larger than the diameter of the pivot bolts 27a, 27b, so that the pivot bolts 27a, 27b can rotate smoothly in the cavity 28.

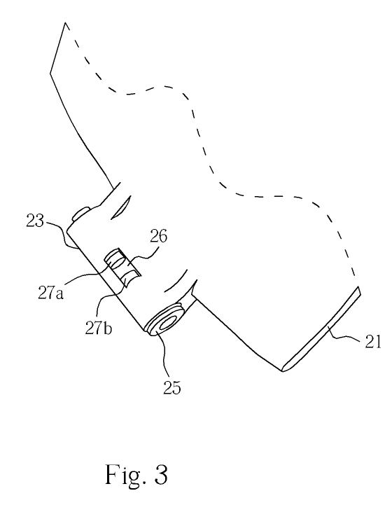

When assembling the pivot assembly 20 according to the present invention, the pivot bolt 27a, 27b are inserted into the hole 25 from the two ends of the support section 23. Please refer to FIG. 3. The outside of the hole 25 covers the front end of the pivot bolts 27a, 27b. Because the individual lengths of the pivot bolts 27a, 27b are longer than the close space of the hole 25, another end of the pivot bolts 27a, 27b is exposed to the hole 25 in the recess 26. Because the total length of the pivot bolts 27a, 27b is shorter than the length of the hole 25, the back ends of the pivot bolts 27a, 27b are exposed in the recess 26 separately.

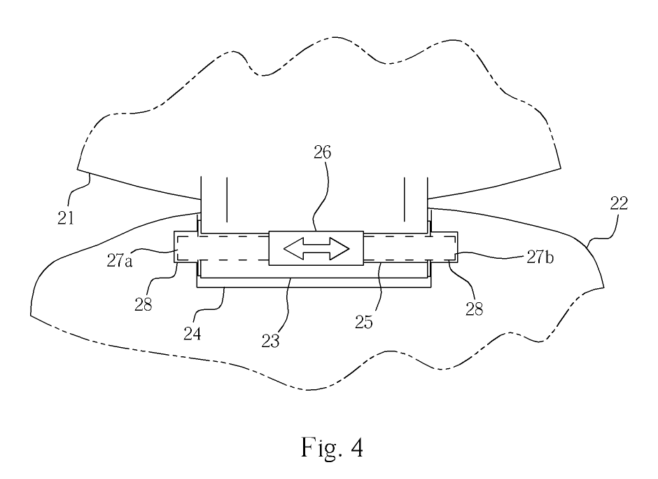

Please refer to FIG. 4. Following, the support section 23 of the rotating body 21 is inserted into the groove 24 of the base 22. Because the front ends of the pivot bolts 27a, 27b are covered completely in the hole 25, the pivot bolts 27a, 27b do not block the support section 23 to be inserted into the groove 24. Therefore, the support section 23 can be easily inserted into the groove 24 without forcing the insertion. After the support section 23 is inserted into the groove 24, the hole 25 is lined up with the cavities 28, and then the back ends of the pivot bolts 27a, 27b are pushed through the recess 26 so as to insert the front ends of the pivot bolts 27a, 27b into the corresponding cavities 28. Finally, the pivot bolts 27a, 27b are fixed in the close space of the hole 25. The fixing method can use a tight fit or bonding with glue. The pivot bolts 27a, 27b use a sliding fit to rotate smoothly in the cavity 28 so that the rotating body 21 and the base 22 are connected to form an included angle or facilitate folding actions.

Because the pivot assembly 20 according to the present invention utilizes the separate pivot bolts 27a, 27b, the support section 23 of the rotating body 21 is inserted into the hole 25 first so as to prevent forcing the support section 23 into the groove 24. By means of the recess 26 in the center of the support section 23, the pivot bolts 27a, 27b are inserted into the cavity 28, so the pivot bolts 27a, 27b can also be prevent from damage and rotate smoothly in the cavity 28. Moreover, the pivot bolts 27a, 27b are properly inserted into the cavity 28 so as to increase the strength of connection and prevent the rotating body 21 and the base 22 from being separated. The strength of the pivot assembly can also be improved so that the rotating body 21 can have enough strength to be a support. Moreover, inserting the pivot bolts 27a, 27b into the cavities 28 through the recess 26 can make assembling the pivot assembly easier and keep the profiles clean so as to increase the quality.

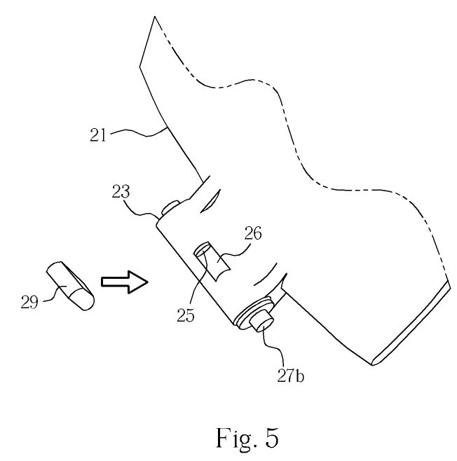

Please refer to FIG. 5. To improve the profile and fix the pivot bolts, in the pivot assembly 20 according to the present invention, after inserting the pivot bolts 27a, 27b into the cavities 28 through the holes 25 of the support section 23, a plug 29 is plugged into the recess 26 so as to hold the back ends of the pivot bolts 27a, 27b for fixing the pivot bolts 27a, 27b, so that the front ends of the pivot bolts 27a, 27b will not shift inward caused by vibration when rotating in the cavity 28. Moreover, the surface of the plug 29 can be flat to the support section 23 and cover the recess 26 to improve the profile.

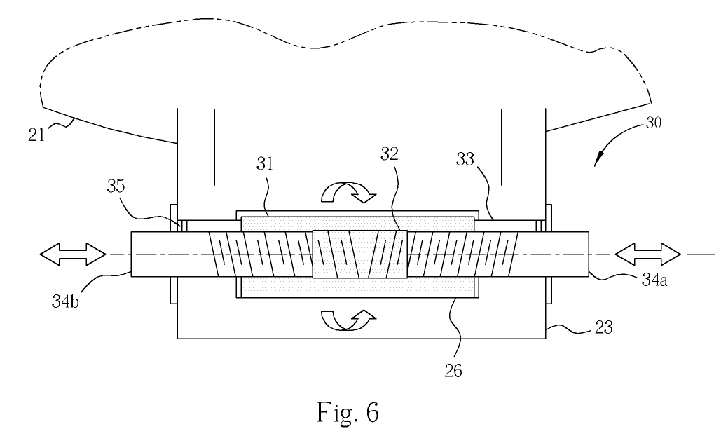

Please refer to FIG. 6, which shows a side view of a second embodiment of a pivot assembly 30 according to the present invention. The pivot assembly 30 has a similar structure to the pivot assembly 20 of the first embodiment, and the difference is in the support section 23. To simplify the explanation, elements of the second embodiment corresponding to the elements of the first embodiment have the same numbers. In the pivot assembly 30 of the second embodiment, an adjuster 31 is installed into the recess 26, and a round opening 32 is formed in the adjuster 31. The diameter of the round opening 32 is coincident to the diameter of the hole 25. The round opening 32 has spirals in different directions on two sides of the round opening 32. A keyway 33 is installed in the hole 25, and a sliding key 35 is installed in each side of the pivot bolts 34a, 34b. The sliding key 35 can slide in the keyway 33. The front end of each pivot bolt 34a, 34b has a spiral corresponding to the round opening 32.

When assembling the pivot assembly 30 of the second embodiment according to the present invention, the adjuster 31 is fixed in the recess 26 and can rotate. The ends of the pivot bolts 34a, 34b having the spiral are inserted into the hole 25 through two sides of the support section 23, so that the sliding key 35 enters the keyway 33. The adjuster 31 is rotated to connect the pivot bolts 34a, 34b to the adjuster 31. Because the sliding key 35 is restricted by the keyway 33, the pivot bolt 34a, 34b will not rotate with the adjuster 31. When adjusting the adjuster 31, the adjuster 31 rotates through the round opening 32 until the front ends of the pivot bolts 34a, 34b enter the holes 25. Then, the support section 23 is inserted into the groove 24. The adjuster 31 is rotate in a reverse direction so that the spiral of the adjuster 31 can drive the pivot bolts 34a, 34b to be exposed to the hole 25 and inserted into the cavity 28. Finally, the pivot bolts 34a, 34b are fixed and supported to rotate smoothly in the cavity 28 to complete the connection of the rotating body 21 and the base 22.

On the other hand, rotating the adjuster 31 in the reverse direction can drive the pivot bolts 34a, 34b to enter the holes 25 to leave the cavities 28, so that the rotating body 21 and the base 22 are separated for repair. The adjuster 31 is also a type of the plug 29, which can make assembling the rotating body 21 and the base 22 easier and cover the recess 26 to improve the profile. Moreover, the adjuster 31 can hold the back ends of the pivot bolts 34a, 34b to prevent from inward shifting caused by the vibration when the pivot bolts 34a, 34b rotate in the cavities 28.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A pivot assembly for connecting a rotating body and a base comprising:
a groove formed on the base with a cavity at each end-face of the groove;
a support section formed on the rotating body to accommodate the groove, the support section having a hole penetrating through two end-faces of the support section corresponding to the cavities of the groove, and a recess above the support section interlinked to the hole; and
two pivot bolts for movably inserting into the hole at two sides of the recess, a front end of each pivot bolt protruding out of the hole for inserting into the cavity.

2. The pivot assembly of claim 1, wherein the pivot bolts are inserted into the hole with a tight fit.

3. The pivot assembly of claim 1, wherein the recess is formed above the support section and interlinked to the center of the hole to form an open channel in the center of the hole and a closed channel at two sides of the hole.

4. The pivot assembly of claim 3, wherein the two pivot bolts are cylindrical with total length shorter than the length of the hole and individual length longer than the closed channel.

5. The pivot assembly of claim 1, wherein the hole is a round hole with a diameter larger than the pivot bolts for the pivot bolts to rotate smoothly.

6. The pivot assembly of claim 1 further comprising:
a plug for plugging into the recess to hold a back end of each pivot bolt.

7. The pivot assembly of claim 6, wherein the plug has a flat surface facing the support section.

8. The pivot assembly of claim 1 further comprising:
an adjuster installed in the recess having a round opening interlinked to the hole, the round opening having spirals in different directions on two sides of the round opening;
wherein the front end of each pivot bolt has a spiral corresponding to the round opening.

9. The pivot assembly of claim 8 wherein the adjuster installed in the recess is capable of rotating.

10. The pivot assembly of claim 8 further comprising:
two sliding keys installed on the outside of the two pivot bolts respectively; and
a keyway formed in the hole for the two sliding keys to move.

11. A method for assembling a pivot assembly comprising:
(a) inserting two pivot bolts into a hole penetrating a support section from two sides of the support section respectively so as to cover a front end of each pivot bolt in the hole and expose a back end of each pivot bolt in a recess formed above the support section;
(b) inserting the support section into a groove formed on a base so that the hole corresponds to a cavity formed on each end-face of the groove;
(c) pushing a back end of each pivot bolt away from the groove so that the front end of each pivot bolt inserts into the cavity; and
(d) fixing the pivot bolts in the hole.

12. The method of claim 11 wherein the step (d) is fixing the pivot bolts in the hole with a tight fit.

13. The method of claim 11 wherein the step (d) is fixing the pivot bolts in the hole with bond glue.

14. The method of claim 11 wherein the step (d) is fixing the pivot bolts in the hole by plugging a plug to hold the pivot bolts.

15. The method of claim 11 wherein the step (a) is utilizing an adjuster installed in the recess having a round opening interlinked to the hole, the round opening having spirals in different directions on two sides of the round opening, each pivot bolt having a spiral corresponding with the round opening, to adjust the adjuster for covering the front end of each pivot bolt in the hole.

16. The method of claim 15 wherein the step (c) is rotating the adjuster so that the front end of each pivot bolt inserts into the cavity.

17. The method of claim 15 wherein the step (d) is fixing the adjuster to fix the pivot bolts in the hole.
